(19) United States
(12) Patent Application Publication
(10) Pub. No.: US 2014/0018011 A1
(43) Pub. Date: Jan. 16, 2014

(54) DIRECT-CONVERSION TRANSCEIVER WITH DC OFFSET COMPENSATION AND THE OPERATION METHOD USING THE SAME

(71) Applicants: Peng-Sen CHEN, Zhubei City (TW); Ming-Chou CHIANG, New Taipei City (TW); Kuei-Ju CHIANG, Hsinchu City (TW)

(72) Inventors: Peng-Sen CHEN, Zhubei City (TW); Ming-Chou CHIANG, New Taipei City (TW); Kuei-Ju CHIANG, Hsinchu City (TW)

(21) Appl. No.: 13/644,917

(22) Filed: Oct. 4, 2012

(30) Foreign Application Priority Data
Jul. 12, 2012 (TW) 101125166

(51) Int. Cl. H04B 1/38

(52) U.S. Cl. 455/73

(57) ABSTRACT

The present invention discloses a direct-conversion transceiver with dc offset compensation, and method using the same. The transceiver mainly comprises an antenna, a first filter, a second filter, a third filter, a first variable gain amplifier with multi-stages, a second variable gain amplifier with multi-stages, a first analog-to-digital converter, a second analog-to-digital converter, a first dc offset loop, a second dc offset loop, a first digital-to-analog converter, a second digital-to-analog converter, a third digital-to-analog converter, a fourth digital-to-analog converter, a third mixer, a fourth mixer, a power amplifier, a local oscillator, and a baseband circuit. By using the second filters, the third filter, the first digital-to-analog converter and the second digital-to-analog converter for both in transmitting mode or receiving mode, the numbers of the filter and digital-to-analog converter can be reduced and thus the circuit area of the transceiver can be further miniaturized.

### BACKGROUND OF THE INVENTION

1. Field of the Invention

The present invention relates to a direct-conversion transceiver with dc offset compensation and the operation method using the same, and in particular to a direct-conversion transceiver with dc offset compensation by using a digital-to-analog converter and the operation method using the same. By sharing the filters of the circuits and the digital-to-analog converters, the demand amount of the filter circuits and the digital-to-analog converters of the direct-conversion transceiver is reduced and the effect of minimizing the circuit size is accomplished.

2. Background

In recent years, wireless communication products are popular, and these products are requested to be minimization and multi-mode designs. Based on the above demands, adopting direct conversion system or low intermediate frequency system for the radio frequency (RF) parts of the products instead of the conventional super-heterodyne system has become a modern trend. Because the direct conversion system needs not the process of intermediate frequency signal but converts directly the radio frequency (RF) signal to baseband signal, thus the direct conversion system is used generally. Due to the omission of the process for the intermediate frequency signal, the direct conversion system is simpler as compared with the super-heterodyne system, and can reduce the circuit size and adopt multi-mode designs for chip design.

In the receiver of the direct conversion system, the based dc offset is produced from the local oscillator and the self-mixing of the input signal. And the dc offset amount of the based dc offset is produced generally from the difference of the energy and frequency between the local oscillator and energy and the frequency of the input signal, or the mismatch of the load of the mixer in the process. The other reason for the dc offset is the mismatch of the process between amplifiers and filter devices, where the variation of the dc offset is varied according to the cut-off frequency of the filters and the gain of the amplifier.

U.S. Pat. No. 6,442,380 discloses an automatic gain controller in a zero intermediate frequency radio device with AC-coupled stages. In FIG. 1, the frequency down converter 500 comprises a low noise amplifier 501, a mixer 502 and a AC-coupler 503. The AC-coupler comprises a capacitor C and a variable resistor R. The first terminal of the capacitor C is connected to an output node Vout, and the second terminal of the capacitor C is connected to the output port of the mixer 502. The first terminal of the variable resistor R is connected to the output node Vout, and the second terminal of the variable resistor R is connected to a port 520 to receive a bias. The AC-coupler 503 comprising a second receiving port 512 is used for receiving a controlled signal to decide the equivalent values of the variable resistor R. The low-noise amplifier 501 comprises an input port and a output port, wherein the input port is connected to a input node Vsig to receive a AC signal, and the output port is connected to the input port of the mixer 502. The mixer 502 comprising a first receiving port 511 is used for receiving a local oscillator signal. The capacitor C and the resistor R are combined into the AC-coupler 503, used for providing the function of high pass filter.

U.S. Pat. No. 6,968,172 discloses a do offset cancel circuit in general. In FIG. 2, the circuit uses the negative feedback of a comparator 620 and a low pass filter 630 to compensate the DC offset of the output signal of the amplifier 610. The circuit can be seen as a high pass filter, namely, a low frequency signal would be filtered through the circuit and then been feedback to compensate the DC offset. However, the disclosed method causes the lower response speed of the signal of the circuit.

FIG. 3 shows a functional block diagram for the conventional radio frequency transceiver. When the radio frequency transceiver is operated in receiving-mode, a signal is received by a antenna 210, and transmitted to a low-noise amplifier 2210 through a filter 211 and a transmitting and receiving mode switch. After enlarging the signal through the low-noise amplifier 2210, a in-phase signal (I-channel) and a quadrature signal (Q-channel) are produced through the functions of a first mixer 2220, a second mixer 2230 and a local oscillator 240. In general, the dc offset signal existed in the in-phase signal (I-channel) and the quadrature signal (Q-channel) is compensated with dc offset through a first digital-to-analog converter 2221 of the receiver and a second digital-to-analog converter 2222 of the receiver, respectively. Then, the in-phase signal (I-channel) and the quadrature signal (Q-channel) are transmitted to a first variable gain amplifier (VGA) 2224 and a second variable gain amplifier (VGA) 2234 through a first filter 2222 of the receiver and a second filter 2232 of the receiver, respectively. Wherein, the dc offset of the output signal of the first filter 2222 is compensated through a third digital-to-analog converter 2223, and dc offset of the output signal of the second filter 2232 is compensated through a fourth digital-to-analog converter 2233. Namely, when the circuit is operated in receiving-mode, four digital-to-analog converters are adopted to compensate dc offset, however, such a circuit design create a problem about the large circuit size.

According to the disadvantage of the prior art, the inventors disclose a direct-conversion transceiver with dc offset compensation and the operation method using the same for reducing the circuit size of the receiver and overcoming the above problems.

### BRIEF SUMMARY OF THE INVENTION

It is an objective of the present invention to provide a direct-conversion transceiver with dc offset compensation using a digital-to-analog converter.

It is another objective of the present invention to provide an operation method used for a direct-conversion transceiver with dc offset compensation using a digital-to-analog converter.

To achieve the above objective, the present invention provides a direct-conversion transceiver with dc offset compensation using a digital-to-analog converter, comprising: an antenna, a first filter, a transmitting and receiving mode switch, a low-noise amplifier, a second filter, a third filter, a first variable gain amplifier (VGA), a second variable gain amplifier (VGA), a first analog-to-digital converter, a second analog-to-digital converter, a first dc offset loop, a second dc offset loop, a first digital-to-analog converter, a second digital-to-analog converter, a third digital-to-analog converter, a fourth digital-to-analog converter, a third mixer, a fourth mixer, a power amplifier, a local oscillator, a baseband circuit. The antenna is used for receiving a radio frequency (RF) signal. The first filter has an input port and an output port and the input port is electrically connected to the antenna. The first filter is used for filtering the radio frequency (RF) signal. The transmitting and receiving mode switch has an input port, a first output port and a second output port, and the input port is electrically connected to the output port of the first filter. The transmitting and receiving mode switch is used for switching transmitting and receiving mode of the direct-conversion transceiver using a digital-to-analog converter for dc offset compensation. The low-noise amplifier has an input port and an output port, and the input port is electrically connected to the first output port of the transmitting and receiving mode switch. The low-noise amplifier is used for enlarging the received radio frequency (RF) signal. The second filter has an input port and an output port, and the input port is electrically connected to the output port of the low-noise amplifier through a first switch and a first mixer. The third filter has an input port and an output port, and the input port is electrically connected to the output port of the low-noise amplifier through a second switch and a second mixer. The first variable gain amplifier (VGA) has an input port and an output port, and the input port is electrically connected to the output port of the second filter through a third switch. The second variable gain amplifier (VGA) has an input port and an output port, and the input port is electrically connected to the output port of the third filter through a fourth switch. The first analog-to-digital converter is electrically connected to the output port of the first variable gain amplifier (VGA). The second analog-to-digital converter is electrically connected to the output port of the second variable gain amplifier (VGA). The first dc offset loop is electrically connected to the input port and the output port of the first variable gain amplifier (VGA) and shunt to the first variable gain amplifier (VGA). The second dc offset loop is electrically connected to the input port and the output port of the second variable gain amplifier (VGA) and shunt to the second variable gain amplifier (VGA). The first digital-to-analog converter is electrically connected to the first switch and the second filter. The second digital-to-analog converter is electrically connected to the second switch and the third filter. The third digital-to-analog converter is electrically connected to second filter and the third switch. The fourth digital-to-analog converter is electrically connected to the third filter and the fourth switch. The third mixer is electrically connected to the third digital-to-analog converter through a fifth switch. The fourth mixer is electrically connected to the fourth digital-to-analog converter through a sixth switch. The power amplifier has an input port and an output port, and the input port is electrically connected to the third mixer and the fourth mixer and the output port is electrically connected to the second output port of the transmitting and receiving mode switch. The local oscillator is electrically connected to the first mixer, the second mixer, the third mixer and the fourth mixer. The baseband circuit is electrically connected to the first analog-to-digital converter, the second analog-to-digital converter, the first digital-to-analog converter and the second digital-to-analog converter.

To achieve another objective, the present invention provides an operation method used for a direct-conversion transceiver with dc offset compensation using a digital-to-analog converter. The operation method comprises the steps of: when the direct-conversion transceiver with dc offset compensation is operated in receiving-mode, the first, second, third, and fourth switches turn on, the fifth and sixth switches turn off, the transmitting and receiving mode switch shifts to the terminal of the low-noise amplifier; and when the direct-conversion transceiver with dc offset compensation is operated in transmitting-mode, the first, second, third, and fourth switches turn off, the fifth and sixth switches turn on, the transmitting and receiving mode switch shifts to the terminal of the power amplifier.

To achieve another objective, the present invention provides an operation used for compensating the dc offset of the direct-conversion transceiver, comprising the steps of: receiving a radio frequency (RF) signal by using the antenna; switching the transmitting and receiving mode switch to the input port of the low-noise amplifier; transmitting the signal to a filter and filtering the signal to generate a first signal, and transmitting the first signal to a low-noise amplifier through the direct-conversion transceiver and enlarging the first signal, and outputting a second signal; mixing the second signal and an oscillator signal, and outputting a third signal and a fourth signal; turning on a first switch and a second switch, wherein the first and second switches provide transmission paths for the third and fourth signals, respectively; outputting a fifth signal and a sixth signal after compensating the dc offset of the third signal and the fourth signal through a first digital-to-analog converter and a second digital-to-analog converter; outputting a seventh signal and a eighth signal by filtering and transmitting the fifth signal and the sixth signals to a second filter and a third filter; turning on a third switch and a fourth, wherein the third and fourth switches provide transmission paths for the seventh and eighth signals, respectively; outputting a ninth signal and a tenth signal after compensating the dc offset of the seventh signal and the eighth signal through a third digital-to-analog converter and a fourth digital-to-analog converter.

To sum up the above arguments, the direct-conversion transceiver with dc offset compensation using a digital-to-analog converter and the operation method using the same according to the invention presents the advantages:

1. The demand amount of the direct-conversion transceivers of the filter circuits and the digital-to-analog converters is reduced by sharing the filters of the circuits and the digital-to-analog converters, and the effect of minimizing the circuit size is accomplished.

2. Due to reducing the demand amount of the direct-conversion transceivers of the filter circuits and the digital-to-analog converters, the reactive rate of the circuit for the signals are increased efficiently.

These and many other advantages and features of the present invention will be readily apparent to those skilled in the art from the following drawings and detailed descriptions.

### BRIEF DESCRIPTION OF THE DRAWINGS

All the objects, advantages, and novel features of the invention will become more apparent from the following detailed descriptions when taken in conjunction with the accompanying drawings.

FIG. 1 shows a zero intermediate frequency radio device of direct conversion down converter with AC-coupled stage of the prior art;

FIG. 2 shows a functional block diagram for the dc offset compensation of the prior art;

FIG. 3 shows a functional block diagram for the dc offset adjustment of the prior art;

FIG. 4 shows a functional block diagram for the direct-conversion transceiver with de offset compensation of the present invention;

FIG. 5 shows a functional block diagram for the direct-conversion transceiver with de offset compensation in transmitting-mode of the present invention; and

FIG. 6 shows a functional block diagram for the direct-conversion transceiver with de offset compensation in receiving-mode of the present invention.

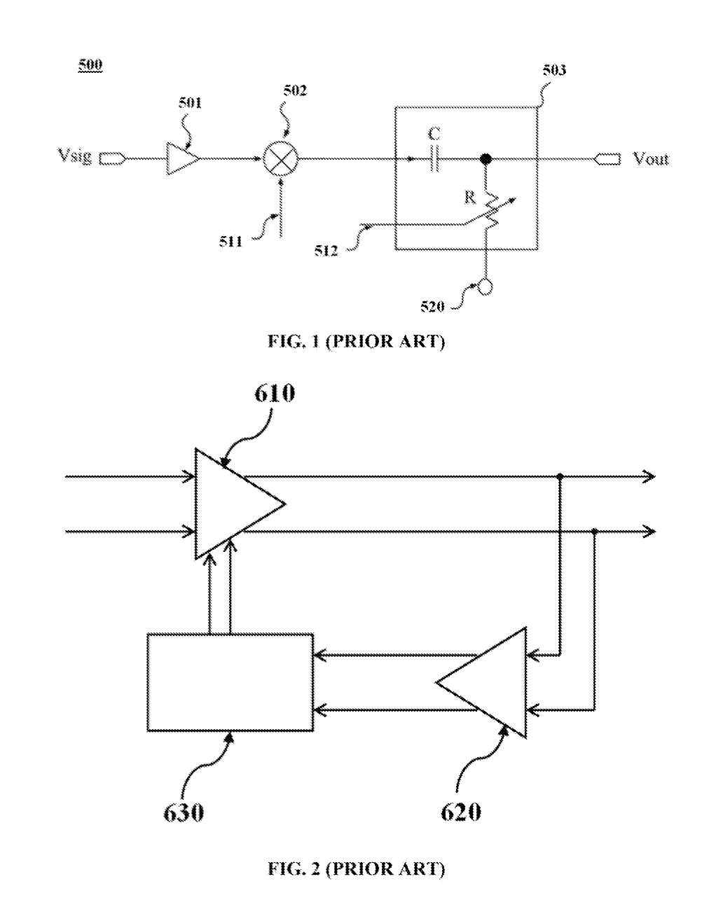

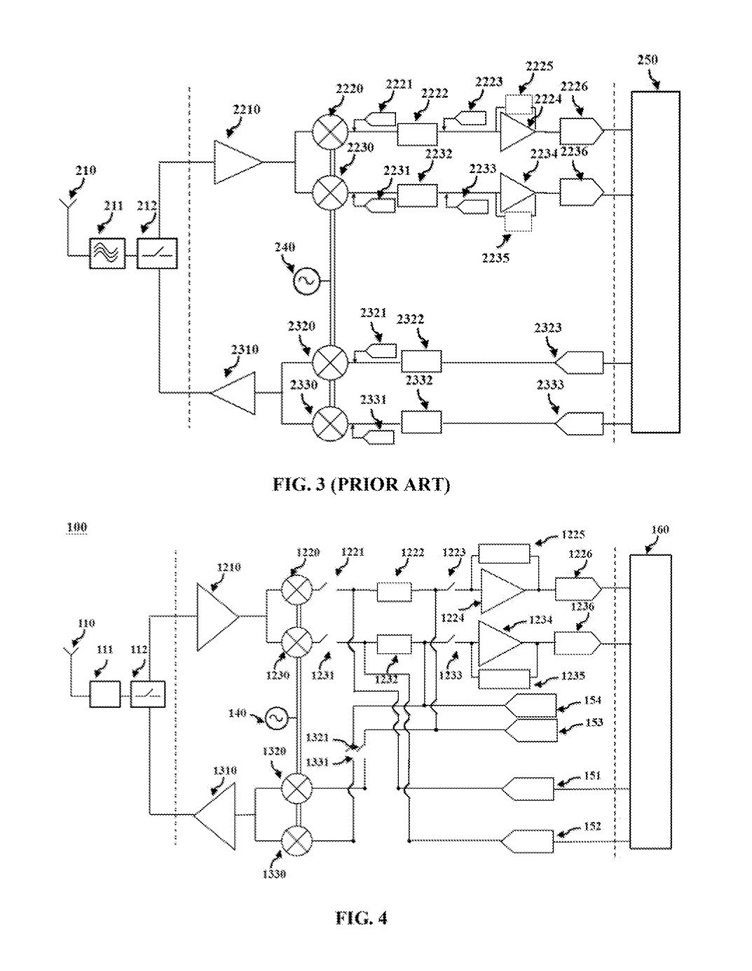

### DETAILED DESCRIPTION OF THE INVENTION

Although the invention has been explained in relation to several preferred embodiments, the accompanying drawings and the following detailed descriptions are the preferred embodiment of the present invention. It is to be understood that the following disclosed descriptions will be examples of present invention, and will not limit the present invention into the drawings and the special embodiment.

To understand the spirit of the present invention, FIG. 4 shows a functional block diagram 100 for the direct-conversion transceiver with dc offset compensation of the present invention. The direct-conversion transceiver 100 with dc offset compensation comprises: an antenna 110, a first filter 111, a transmitting and receiving mode switch 112, a low-noise amplifier 1210, a second filter 1222, a third filter 1232, a first variable gain amplifier (VGA) 1224, a second variable gain amplifier (VGA) 1234, a first analog-to-digital converter 1226, a second analog-to-digital converter 1236, a first dc offset loop 1225, a second dc offset loop 1235, a first digital-to-analog converter 151, a second digital-to-analog converter 152, a third digital-to-analog converter 153, a fourth digital-to-analog converter 154, a third mixer 1320, a fourth mixer 1330, a power amplifier 1310, a local oscillator 140, a baseband circuit 160.

Note also here, in order to reach the standard quality of low-noise for the low-noise amplifier 1210, the low-noise amplifier 1210 should consist of multi-stage of low-noise amplifiers. In order to reach the standard quality of gain for the first variable gain amplifier (VGA) 1224 and the second variable gain amplifier (VGA) 1234, the first variable gain amplifier (VGA) 1224 and the second variable gain amplifier (VGA) 1234 should consist of multi-stage of gain amplifiers.

The antenna 110 is used for receiving a radio frequency (RF) signal. The first filter 111 has an input port and an output port, and the input port is electrically connected to the antenna 110. The first filter is used for filtering the radio frequency (RF) signal. The transmitting and receiving mode switch 112 has an input port, a first output port and a second output port, and the input port is electrically connected to the output port of the first filter 111. The transmitting and receiving mode switch 112 is used for switching transmitting and receiving mode of the direct-conversion transceiver 100 using a digital-to-analog converter for dc offset compensation. The low-noise amplifier 1210 has an input port and an output port, and the input port is electrically connected to the first output port of the transmitting and receiving mode switch 112. The low-noise amplifier 1210 is used for enlarging the received radio frequency (RF) signal. The second filter 1222 has an input port and an output port, and the input port is electrically connected to the output port of the low-noise amplifier 1210 through a first switch 1221 and a first mixer 1220. The third filter 1232 has an input port and an output port, and the input port is electrically connected to the output port of the low-noise amplifier 1210 through a second switch 1231 and a second mixer 1230.

The first variable gain amplifier (VGA) 1224 has an input port and an output port, and the input port is electrically connected to the output port of the second filter 1222 through a third switch 1223. The second variable gain amplifier (VGA) 1234 has an input port and an output port, and the input port is electrically connected to the output port of the third filter 1232 through a fourth switch 1233. The first analog-to-digital converter 1226 is electrically connected to the output port of the first variable gain amplifier (VGA) 1224. The second analog-to-digital converter 1236 is electrically connected to the output port of the second variable gain amplifier (VGA) 1234. The first dc offset loop 1225 is electrically connected to the input port and the output port of the first variable gain amplifier (VGA) 1224 and shunt to the first variable gain amplifier (VGA) 1224. The second dc offset loop 1235 is electrically connected to the input port and the output port of the second variable gain amplifier (VGA) 1234 and shunt to the second variable gain amplifier (VGA) 1234.

The first digital-to-analog converter 151 is electrically connected to the first switch 1221 and the second filter 1222. The second digital-to-analog converter 152 is electrically connected to the second switch 1231 and the third filter 1232. The third digital-to-analog converter 153 is electrically connected to second filter 1222 and the third switch 1223. The fourth digital-to-analog converter 154 is electrically connected to the third filter 1232 and the fourth switch 1233. The third mixer 1320 is electrically connected to the third digital-to-analog converter 153 through a fifth switch 1321. The fourth mixer 1330 is electrically connected to the fourth digital-to-analog converter 154 through a sixth switch 1331. The power amplifier 130 has an input port and an output port, and the input port is electrically connected to the third mixer 1320 and the fourth mixer 1330 and the output port is electrically connected to the second output port of the transmitting and receiving mode switch 112. The local oscillator 140 is electrically connected to the first mixer 1220, the second mixer 1230, the third mixer 1320 and the fourth mixer 1330. The baseband circuit 160 is electrically connected to the first analog-to-digital converter 1226, the second analog-to-digital converter 1236, the first digital-to-analog converter 151 and the second digital-to-analog converter 152.

The direct-conversion transceiver 100 with dc offset compensation using the digital-to-analog converter is a zero-IF transceiver.

When the direct-conversion transceiver 100 with dc offset compensation using the digital-to-analog converter is operated in receiving-mode, the first digital-to-analog converter 151 and the second digital-to-analog converter 152 compensate the DC of the output signals of the first mixer 1220 and the second mixer 1230.

When the direct-conversion transceiver 100 with dc offset compensation using a digital-to-analog converter is operated in receiving-mode, the third digital-to-analog converter 153 and the fourth digital-to-analog converter 154 compensate the DC of the output signals of the second filter 1222 and the third filter 1232.

When the direct-conversion transceiver 100 with dc offset compensation using the digital-to-analog converter is operated in transmitting-mode, the first digital-to-analog converter 151 and the second digital-to-analog converter 152 convert the output digital signal of the baseband circuit 160 to the analog signal.

Note also here, the transistors of above active circuit can be implemented by using 0.18 μm, 0.13 μm, 0.09 μm, 0.045 μm, or more advanced process, wherein the transistor can be implemented as: Bipolar Junction Transistor (BJT), Heterojunction Bipolar Transistor (HBT), High Electronic Mobility Transistor (HEMT), Pseudomorphic HEMT (PHEMT), Complementary Metal Oxide Semiconductor Filed Effect Transistor (CMOS) and Laterally Diffused Metal Oxide Semiconductor Filed Effect Transistor (LDMOS). Preferably, PHEMT is suitable for the gain stage and power stage in the microwave to millimeter wave range. Semiconductor materials broadly applicable to the gain stage and power stage include: silicon, silicon-on-insulator (SOI), silicon-germanium (SiGc), gallium arsenide (GaAs), indium phosphide (InP) and silicon-germanium-carbon (SiGe—C) materials.

When the direct-conversion transceiver with dc offset compensation is operated in wireless local area network (WLAN) system, the bandwidth of the second filter 1222 is 9.4 MHz. The first switch 1221, the second switch 1231, the third switch 1223, the fourth switch 1233, the fifth switch 1321 and the sixth switch 1331 are switching devices of complementary metal-oxide-semiconductor (CMOS). In addition, when the circuit is operated in bluetooth system, the output bits of the first digital-to-analog converter 151 is from 5 to 8 bits.

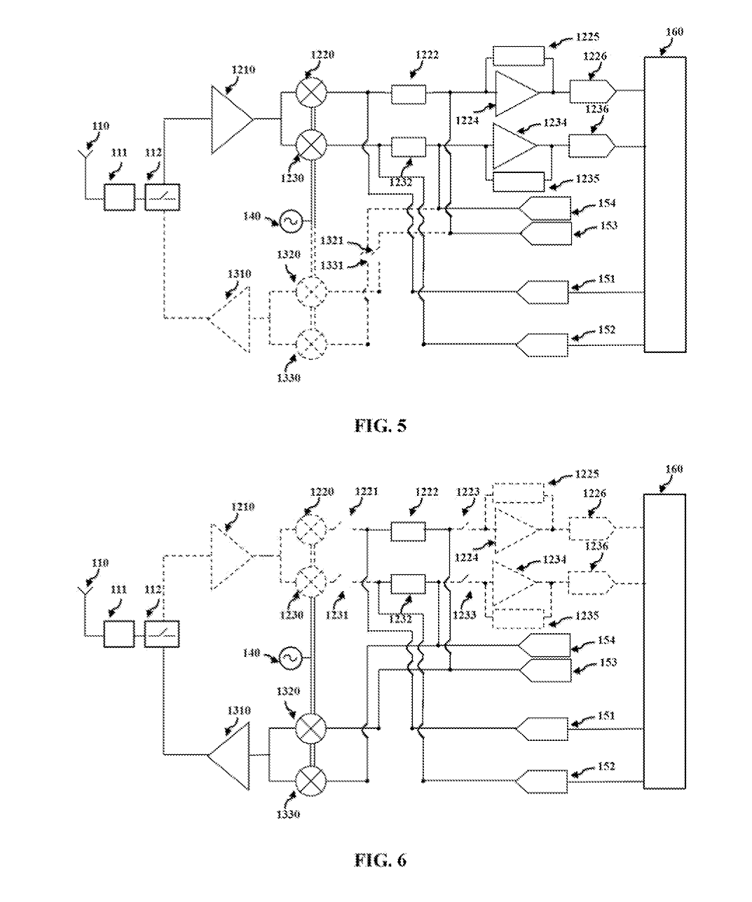

In addition, the present invention discloses an operation method used for a direct-conversion transceiver with dc offset compensation using a digital-to-analog converter. Note also here, FIG. 4 shows the used circuit of the method of the present invention. To understand the spirit of the present invention, FIG. 5 shows a functional block diagram for direct-conversion transceiver with dc offset compensation using a digital-to-analog converter of the present invention in receiving-mode. FIG. 6 shows a functional block diagram for direct-conversion transceiver with dc offset compensation of a digital-to-analog converter of the present invention in transmitting-mode. The operation method comprises the steps of:

When the direct-conversion transceiver 100 of a digital-to-analog convert is operated in receiving-mode, a first switch 1221, a second switch 1231, a third switch 1223, and a fourth switch 1233 turn on, a fifth switch 1321 and a sixth switch 1331 turn off; the transmitting and receiving mode switch 112 shifts to the terminal of the low-noise amplifier 1210;

receiving a radio frequency (RF) signal by using an antenna 110;

transmitting a radio frequency (RF) signal to a low-noise amplifier 1210 and outputting a first signal by using a first filter 111 and a transmitting and receiving mode switch 112;

converting the first signal to a second signal by using a first mixer 1220 and a local oscillator 140;

converting the first signal to a third signal by using a second mixer 1230 and a local oscillator 140, wherein the phase difference between the second and third signal is ninety degrees (90°);

exporting the second signal to a second filter 1222 after compensating the dc offset of the second signal by using a first digital-to-analog converter 151;

exporting the third signal to a third filter 1232 after compensating the dc offset of the third signal by using a second digital-to-analog converter 152;

compensating the dc offset of a fourth signal of the output of the second filter 1222 and the dc offset of a fifth signal of the output of the third filter 1232 by using a third digital-to-analog converter 153 and a fourth digital-to-analog converter 154, respectively;

outputting the fourth signal to a baseband circuit 160 by using a first variable gain amplifier (VGA) 1224, a first dc offset loop 1225, and a first analog-to-digital converter 1226; and

outputting the fifth signal to the baseband circuit 160 by using a second variable gain amplifier (VGA) 1234, a second dc offset loop 1235, and a second analog-to-digital converter 1236.

When the direct-conversion transceiver 100 of a digital-to-analog convert is operated in transmitting-mode, a first switch 1221, a second switch 1231, a third switch 1223, and a fourth switch 1233 turn off, a fifth switch 1321 and a sixth switch 1331 turn on, the transmitting and receiving mode switch 112 shifts to the terminal of the power amplifier 1310;

generating a sixth signal and a seventh signal by using the baseband circuit 160;

outputting the sixth signal to the second filter 1222 after converting the sixth signal from digital to analog by using the first digital-to-analog converter 151;

outputting the seventh signal to the third filter 1232 after converting the seventh signal from digital to analog by using the second digital-to-analog converter 152;

compensating the dc offset of a eighth signal of the output of the second filter 1222 and the dc offset of a ninth signal of the output of the third filter 1232 by using the third digital-to-analog converter 153 and the fourth digital-to-analog converter 154, respectively;

outputting the eighth signal to the power amplifier 1310 after raising the frequency of the eighth signal by using a third mixer 1320 and the local oscillator 140;

outputting the ninth signal to the power amplifier 1310 after raising the frequency of the ninth signal by using a fourth mixer 1330 and the local oscillator 140; and

launching a tenth signal of the output of the power amplifier 1310 through the antenna 110.

According to the above systems, the present invention discloses a method of a direct-conversion transceiver with dc offset compensation. The method comprises the steps of: receiving a signal by using an antenna 110; switching the transmitting and receiving mode switch 112 to the input port of the low-noise amplifier 1210; transmitting the signal to a first filter 111 and filtering the signal to generate a first signal, and transmitting the first signal to the low-noise amplifier 1210 through the direct-conversion transceiver and enlarging the first signal, and outputting a second signal; mixing the second signal and an oscillator signal, and outputting a third signal and a fourth signal; turning on a first switch 1221 and a second switch 1231, wherein the first switch 1221 and the second switch 1231 provide transmission paths for the third and fourth signals, respectively; outputting a fifth signal and a sixth signal after compensating the dc offset of the third signal and the fourth signal through a first digital-to-analog converter 151 and a second digital-to-analog converter 152; outputting a seventh signal and a eighth signal by filtering and transmitting the fifth signal and the sixth signals to a second filter 1222 and a third filter 1233; turning on a third switch 1223 and a fourth switch 1233, where in the third switch 1223 and the fourth switch 1233 provide transmission paths for the seventh and eighth signals, respectively; and outputting a ninth signal and a tenth signal after compensating the dc offset of the seventh signal and the eighth signal through a third digital-to-analog converter 153 and a fourth digital-to-analog converter 154. When switching the transmitting and receiving mode switch 112 to the input port of the power amplifier 1310, the first switch 1221, the second switch 1231, the third switch 1223 and the fourth switch 1233 turn off, and the first digital-to-analog converter 151, the second digital-to-analog converter 152, the third digital-to-analog converter 153 and the fourth digital-to-analog converter 154 are not used for dc offset compensation, and a fifth switch 1321 and a sixth switch 1331 turn on.

Although the invention has been explained in relation to its preferred embodiment, it is not used to limit the invention. It is to be understood that many other possible modifications and variations can be made by those skilled in the art without departing from the spirit and scope of the invention as hereinafter claimed.

What is claimed is:

1. A direct-conversion transceiver with dc offset compensation, comprising:
an antenna, used for receiving a radio frequency (RF) signal;
a first filter, having an input port and an output port, the input port electrically connected to the antenna, the first filter used for filtering the radio frequency (RF) signal;
a transmitting and receiving mode switch, having an input port, a first output port and a second output port, the input port electrically connected to the output port of the first filter, the transmitting and receiving mode switch used for switching transmitting and receiving mode of the direct-conversion transceiver using a digital-to-analog converter for dc offset compensation;
a low-noise amplifier, having an input port and an output port, the input port electrically connected to the first output port of the transmitting and receiving mode switch, low-noise amplifier used for enlarging the received radio frequency (RF) signal;
a second filter, having an input port and an output port, the input port electrically connected to the output port of the low-noise amplifier through a first switch and a first mixer;
a third filter, having an input port and an output port, the input port electrically connected to the output port of the low-noise amplifier through a second switch and a second mixer;
a first variable gain amplifier (VGA), having an input port and an output port, the input port electrically connected to the output port of the second filter through a third switch;
a second variable gain amplifier (VGA), having an input port and an output port, the input port electrically connected to the output port of the third filter through a fourth switch;
a first analog-to-digital converter, electrically connected to the output port of the first variable gain amplifier (VGA);
a second analog-to-digital converter, electrically connected to the output port of the second variable gain amplifier (VGA);
a first dc offset loop, electrically connected to the input port and the output port of the first variable gain amplifier (VGA) and shunt to the first variable gain amplifier (VGA);
a second dc offset loop, electrically connected to the input port and the output port of the second variable gain amplifier (VGA) and shunt to the second variable gain amplifier (VGA);
a first digital-to-analog converter, electrically connected to the first switch and the second filter;
a second digital-to-analog converter, electrically connected to the second switch and the third filter;
a third digital-to-analog converter, electrically connected to second filter and the third switch;
a fourth digital-to-analog converter, electrically connected to the third filter and the fourth switch;
a third mixer, electrically connected to the third digital-to-analog converter through a fifth switch;
a fourth mixer, electrically connected to the fourth digital-to-analog converter through a sixth switch;
a power amplifier, having an input port and an output port, the input port electrically connected to the third mixer and the fourth mixer, and the output port electrically connected to the second output port of the transmitting and receiving mode switch;
a local oscillator, electrically connected to the first mixer, the second mixer, the third mixer and the fourth mixer; and
a baseband circuit, electrically connected to the first analog-to-digital converter, the second analog-to-digital converter, the first digital-to-analog converter and the second digital-to-analog converter.

2. A direct-conversion transceiver with dc offset compensation as claimed in claim 1, wherein the direct-conversion transceiver with dc offset compensation using the digital-to-analog converter is a zero-IF transceiver.

3. A direct-conversion transceiver with dc offset compensation as claimed in claim 1, wherein when the direct-conversion transceiver with dc offset compensation using the digital-to-analog converter is operated in receiving-mode, the first digital-to-analog converter and the second digital-to-analog converter compensate the DC of the output signals of the first mixer and the second mixer.

4. A direct-conversion transceiver with dc offset compensation as claimed in claim 1, wherein when the direct-conversion transceiver with dc offset compensation using the digital-to-analog converter is operated in receiving-mode, the third digital-to-analog converter and the fourth digital-to-analog converter compensate the DC of the output signals of the second filter and the third filter.

5. A direct-conversion transceiver with dc offset compensation as claimed in claim 1, wherein when the direct-conversion transceiver with dc offset compensation using the digital-to-analog converter is operated in transmitting-mode, the first digital-to-analog converter and the second digital-to-analog converter convert the output digital signal of the baseband circuit to the analog signal.

6. An operation method of a direct-conversion transceiver with dc offset compensation, comprising steps of:
when the direct-conversion transceiver with dc offset compensation in receiving-mode, the first switch, the second switch, the third switch, and the fourth switch turn on, the fifth switch and the sixth switch turn off, the transmitting and receiving mode switch shifts to the terminal of the low-noise amplifier; and
when the direct-conversion transceiver with dc offset compensation in transmitting-mode, the first switch, the second switch, the third switch, and the fourth switch turn off, the fifth switch and the sixth switch turn on, the transmitting and receiving mode switch shifts to the terminal of the power amplifier.

7. An operation method of a direct-conversion transceiver with dc offset compensation as claimed in claim 6, when the direct-conversion transceiver with dc offset compensation as claimed in claim 1 in receiving-mode, comprising steps of:
receiving a radio frequency (RF) signal by using the antenna;
transmitting the radio frequency (RF) signal to the low-noise amplifier and outputting a first signal by using the first filter and the transmitting and receiving mode switch;
converting the first signal to a second signal by using the first mixer and the local oscillator;
converting the first signal to a third signal by using the second mixer and the local oscillator, wherein the phase difference between the second and third signal is ninety degrees (90°);
outputting the second signal to a second filter after compensating the dc offset of the second signal by using the first digital-to-analog converter;
outputting the third signal to a third filter after compensating the dc offset of the third signal by using the second digital-to-analog converter;
compensating the dc offset of a fourth signal of the output of the second filter and the dc offset of a fifth signal of the output of the third filter by using the third digital-to-analog converter and the fourth digital-to-analog converter, respectively;
outputting the fourth signal to the baseband circuit by using the first variable gain amplifier (VGA), the first do offset loop, and the first analog-to-digital converter;
outputting the fifth signal to the baseband circuit by using the second variable gain amplifier (VGA), the second dc offset loop, and the second analog-to-digital converter.

8. An operation method of a direct-conversion transceiver with do offset compensation as claimed in claim 6, when the direct-conversion transceiver with dc offset compensation as claimed in claim 1 in transmitting-mode, comprising steps of:
generating a sixth signal and a seventh signal by using the baseband circuit;
outputting the sixth signal to the second filter after converting the sixth signal from digital to analog by using the first digital-to-analog converter;
outputting the seventh signal to the third filter after converting the seventh signal from digital to analog by using the second digital-to-analog converter;
compensating the dc offset of a eighth signal of the output of the second filter and the dc offset of a ninth signal of the output of the third filter by using the third digital-to-analog converter and the fourth digital-to-analog converter, respectively;
outputting the eighth signal to the power amplifier after raising the frequency of the eighth signal by using the third mixer and the local oscillator;
outputting the ninth signal to the power amplifier after raising the frequency of the ninth signal by using the fourth mixer and the local oscillator; and
launching a tenth signal of the output of the power amplifier through the antenna.
